(19) United States
(12) Patent Application Publication
(10) Pub. No.: US 2008/0314370 A1
(43) Pub. Date: Dec. 25, 2008

(54) Vehicle fuel preheater

(76) Inventor: Christopher D. Weiche, Tulsa, OK (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/213,647

(22) Filed: Jun. 23, 2008

Related U.S. Application Data
(60) Provisional application No. 60/929,354, filed on Jun. 22, 2007.

(51) Int. Cl. F02G 5/00

(52) U.S. Cl. 123/557

(57) ABSTRACT

The vehicle fuel preheater works on the known fact that by preheating the fuel, the fuel is more effectively vaporized, resulting in more efficient combustion. This preheating is accomplished using heat that normally cycles through the heater core for interior heat. The preheater, i.e., heat exchanger, has a housing, through which heated engine coolant on its way from the cooling pump to the heater core is routed. A coiled copper gas line is routed through the housing, and is connected between a segment of the fuel line and the engine combustion chamber so that the preheater can deliver preheated fuel to the combustion chamber. The heat exchanger is installed in a vertical orientation to prevent air lock in the fuel and cooling systems.

### CROSS-REFERENCE TO RELATED APPLICATION

This application claims the benefit of U.S. Provisional Patent Application Ser. No. 60/929,354, filed Jun. 22, 2007.

### BACKGROUND OF THE INVENTION

1. Field of the Invention

The present invention relates to internal combustion engines, and particularly to a vehicle fuel preheater that produces more effective vaporization and combustion in internal combustion engines.

2. Description of the Related Art

In any internal combustion engine, fuel is vaporized and mixed with air for combustion. It is known that preheating gasoline or other fuel for internal combustion engines can produce more efficient vaporization and higher combustion efficiency and engine performance than cold fuel. However, preheating the fuel is often not practical because of other problems that may result, such as restrictions of cooling systems, air lock, and the like. While preheating heat exchangers have been developed that connect in the primary cooling system between the radiator and engine block of the vehicle to provide the thermal energy for heating the fuel, such systems require constant monitoring and possible maintenance because any clogging will shut down the vehicle engine cooling system.

Thus, a vehicle fuel preheater solving the aforementioned problems is desired.

### SUMMARY OF THE INVENTION

The vehicle fuel preheater works on the known fact that by preheating the fuel, the fuel is more effectively vaporized, resulting in more efficient combustion. This preheating is accomplished using heat that normally cycles through the heater core for interior heat. The preheater, i.e., heat exchanger, has a housing through which heated engine coolant on its way from the cooling pump to the heater core is routed. A coiled copper gas line is routed through the housing, and is connected between the regular fuel line and the engine. The heat exchanger is preferably versatile enough that it can be installed in a vertical orientation to prevent air lock.

These and other features of the present invention will become readily apparent upon further review of the following specification and drawings.

### BRIEF DESCRIPTION OF THE DRAWINGS

FIG. 1 is a diagrammatic environmental view of a vehicle fuel preheater according to the present invention.

FIG. 2 is a front view in section of a vehicle fuel preheater according to the present invention.

Similar reference characters denote corresponding features consistently throughout the attached drawings.

### DETAILED DESCRIPTION OF THE PREFERRED EMBODIMENT

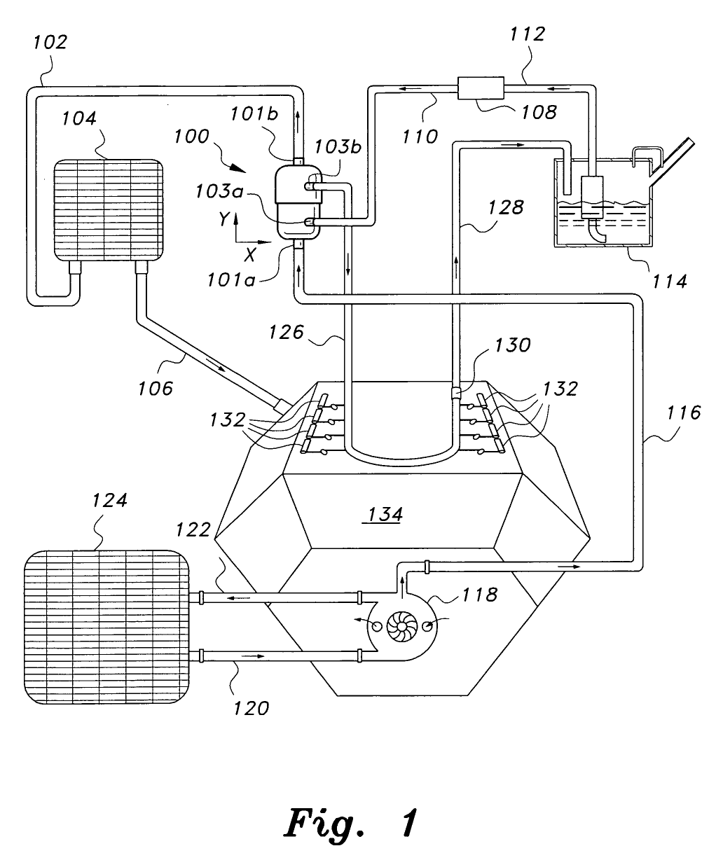

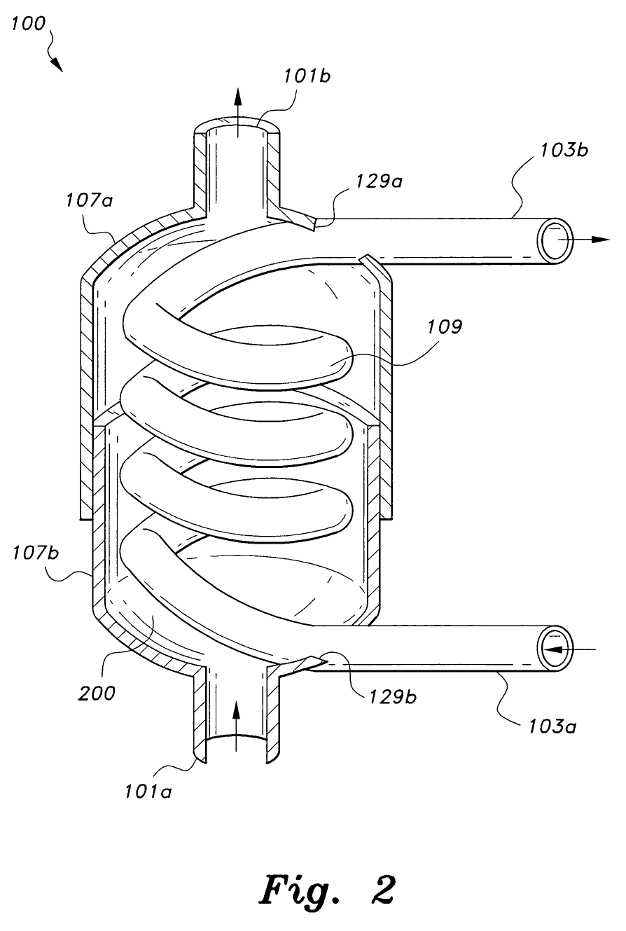

The present invention is a vehicle fuel preheater that works on the known fact that by preheating the fuel, the fuel is more effectively vaporized, resulting in more efficient combustion. As shown in FIGS. 1-2, this preheating is accomplished using heat that normally cycles through a heater core 104 for interior heat. Preferably, the heater core bypass coolant that circulates through the heat exchanger, i.e., preheater 100, is at a temperature of approximately 220° F. The preheater 100 has a housing comprising upper shell 107a and lower shell 107b, through which heated engine coolant on its way from the cooling pump 118 to the heater core 104 is routed. Preferably the housing shells 107a and 107b are made of copper. Copper construction of all of the components of fuel preheater 100 facilitates ease of soldering the components together because copper can bond under a low temperature solder. Moreover, copper can more effectively exchange heat, lessen corrosion, and can accommodate the fuel pressure and coolant pressure of modern automotive fuel and cooling systems, and is cost effective in doing so.

Each housing shell 107a, 107b has a cavity, the bottom housing shell 107b having a smaller outer diameter than the upper shell 107a. This configuration allows the bottom shell 107b to be compression fitted into the upper shell 107a. The joint created by the fitting can be soldered to secure the housing through which the coolant can flow. The lower shell 107b has an inlet 101a. The upper shell 107a has an outlet 101b. The housing shell cavities define a passageway 200 for coolant to travel into the inlet 101a, and exit from the outlet 110b.

Disposed in the upper and lower shells 107a and 107b are a respective two coil apertures 129a and 129b through which outlet 103b and inlet 103a of heat transfer coil 109 may be fitted. The coiled portion of heat transfer coil 109 is disposed inside the passageway 200 created by the housing shells 107a and 107b. Heat from coolant that flows through the passageway 200 is transferred to the coil 109 to heat fuel flowing through the coil 109. The coiled copper heat transfer coil 109 functions as a fuel heating gas line that is routed through the housing and is connected between fuel line segment 110 and fuel line combustion chamber feeder segment 126 in order to supply heated fuel to the engine 134. Due to efficiency of the heat exchanger configuration, the output of the heat exchanger is expected to introduce fuel at a temperature of approximately between 180 and 210° F. to the fuel injectors.

As shown in FIG. 1, the heat exchanger is installed in a compartment of engine 134 in a preferably vertical orientation to prevent air lock in the fuel and cooling systems. Due to the fact that fuel preheater 100 uses ancillary discharge line 116 from coolant pump 118, circulation from the coolant pump 118 via main discharge pipe 122 into radiator 124 and circulation from the radiator 124 via main inlet pipe 120 back to the coolant pump 118 remain undisturbed by the fuel preheater 100 of the present invention. Ancillary discharge line 116 from coolant pump 118 is routed and connected to preheater coolant inlet 101a to allow ancillary coolant discharge fluid, which may range between approximately 180° to approximately 220°, to flow into the preheater passageway 200.

Heater core inlet pipe 102 is connected to fuel preheater coolant outlet 101b and then routed to the heater core 104 to allow the coolant fluid to flow into the heater core 104. The coolant fluid then flows out of the heater core 104 into engine 134 via heater core outlet pipe 106.

Referring again to FIG. 1, the fuel circuit is completed as follows. Unheated fuel in fuel tank 114 flows via fuel filter inlet pipe 112 into the inlet of fuel filter 108. Fuel flow continues via fuel filter outlet pipe 110. The fuel filter outlet pipe 110 is routed and connected to fuel inlet 103a of fuel preheater 100. Fuel is then permitted to flow through the heat exchange coil 109 of the fuel preheater 100. Heated fuel leaving fuel outlet 103b of the preheater 100 is routed to fuel injectors 132 via fuel rail 126. As in engine operations without a preheater, fuel regulator 130 returns unspent fuel back to the fuel tank 114 via unused fuel return line 128.

It is to be understood that the present invention is not limited to the embodiment described above, but encompasses any and all embodiments within the scope of the following claims.

I claim:

1. A vehicle engine fuel preheater, comprising:
a copper housing having a coolant inlet adapted for connection to a cooling pump discharge hose of a vehicle engine, and a coolant outlet adapted for connection to a heater core inlet pipe of the engine for flow of coolant through the housing, the housing defining a passageway for coolant between the coolant inlet and the coolant outlet; and
a coiled copper conduit adapted for connection inline with a fuel line of the engine, the conduit passing through the housing and having a coiled portion of the conduit disposed in the housing, the housing and the coil being adapted for mounting vertically in the vehicle engine.

2. The vehicle engine fuel preheater according to claim 1, wherein said housing is comprises a first housing shell and a second housing shell, the housing shells being joined together.

3. The vehicle engine fuel preheater according to claim 2, wherein the first housing shell and the second housing shell are joined together by a compression fit.

4. A vehicle engine fuel preheater, comprising:
a housing having a coolant inlet and a coolant outlet adapted for insertion into a vehicle engine cooling system so that engine coolant flows through the housing;
a fuel inlet port defined in the housing;
a fuel outlet port defined in the housing; and
a tubular heat exchange coil disposed in the housing and extending between the fuel inlet port and the fuel outlet port, the fuel inlet port and fuel outlet port being adapted for insertion into the vehicle engine fuel line so that fuel flowing through the fuel line is preheated in the heat exchange coil by heat exchange with coolant flowing through the housing prior to entering a combustion chamber of the vehicle engine.

5. The vehicle engine fuel preheater according to claim 4, wherein said heat exchange coil is made from copper.

6. The vehicle engine fuel preheater according to claim 4, wherein said housing is made from copper.

7. The vehicle engine fuel preheater according to claim 4, wherein said housing and said coil are vertically aligned.

8. The vehicle engine fuel preheater according to claim 7, wherein said housing comprises an upper component and a lower component joined together by compression fit.
